(19) United States
(12) Patent Application Publication
(10) Pub. No.: US 2007/0236651 A1
(43) Pub. Date: Oct. 11, 2007

(54) Spectacles and sunshade -clip assembly using magnets

(76) Inventors: Suk-Jae Lee, Daegu (KR); Ju-Jae Lee, Daegu (KR); Hyun-Jun Lee, Daegu (KR); Sung-Jun Lee, Daegu (KR)

Correspondence Address: ST. ONGE STEWARD JOHNSTON & REENS, LLC, 986 BEDFORD STREET, STAMFORD, CT, 06905-5619, US

(21) Appl. No.: 11/392,426

(22) Filed: Mar. 29, 2006

(51) Int. Cl. G02C 9/00

(52) U.S. Cl. 351/47

(57) ABSTRACT

Disclosed herein is a spectacles and sunshade-clip assembly in which a sunshade-clip is detachably attached to spectacles by use of a plurality of magnets. The sunshade-clip includes clip magnets inserted into magnet ribs at opposite ends of the sunshade-clip, and at least one clip bridge magnet inserted into a clip bridge. The spectacles include spectacle magnets inserted into hinge members at opposite ends of the spectacles to correspond to the clip magnets, and at least one spectacle bridge magnet inserted into a spectacle bridge to correspond to the clip bridge magnet. When the magnets of the sunshade-clip are coupled to the magnets of the spectacles, the magnets are positioned to be spaced apart forward from arc axes that are center axes of curved spectacle lens frames.

### FIELD OF THE INVENTION

The present invention relates to a spectacles and sunshade-clip assembly using magnets, and more particularly, to a spectacles and sunshade-clip assembly in which a sunshade-clip can be detachably attached to spectacles through use of a plurality of magnets.

### BACKGROUND OF THE INVENTION

Recently, a sunshade-clip having a pair of colored sunshade lenses has been developed. The sunshade-clip is designed to be detachably attached to spectacles by use of certain attachment means, for example, magnets. To be closely attached to the spectacles, therefore, the sunshade lenses of the sunshade-clip generally have the same shape as prescription lenses of the spectacles.

Various different configurations of spectacles and sunshade-clip assembly using magnets have been conventionally proposed in the art. However, the proposed configurations have been found to exhibit the following problems when in use.

Considering first the conventional configuration of the conventional sunshade-clip that includes the sunshade-lenses having the same shape as that of the prescription lenses of the spectacles, the sunshade-clip may be provided with a pair of arm members for receiving magnets. The arm members are generally configured to protrude from opposite ends of the sunshade-clip toward the spectacles, and correspondingly, the spectacles may be provided with one or more magnets at various positions corresponding to the magnets of the sunshade-clip. Thereby, when the sunshade-clip is attached to the spectacles by use of the magnets, the spectacles are able to be used as sunglasses. Alternatively, the sunshade-clip may be configured to be caught by a nose bridge of the spectacles without using the magnets.

A problem of the above described conventional configuration is in that the arm members, which protrude from opposite ends of the sunshade-clip, may deteriorate the outer appearance of the spectacles and sunshade-clip assembly. Furthermore, when the sunshade-clip is attached to the spectacles by use of the magnets provided at opposite ends thereof or is caught by the nose bridge of the spectacles, the spectacles and sunshade-clip assembly exhibits a low coupling force, and thus, the sunshade-clip is liable to be unintentionally detached from the spectacles when in use by the weight thereof or upon receiving external shock.

The deterioration in the outer appearance of the spectacles and sunshade-clip assembly due to outwardly protruding magnet receiving members, for example, arm members, magnet ribs, etc., is the most important problem in the view of the present invention. This may result in consumer apprehension, and thus, may cause low sales volume.

As a solution of the above problem, the applicant of the present invention filed American patent application Ser. No. 11/060,758 on Feb. 18, 2005, which is entitled “SPECTACLES AND SUNSHADE-CLIP ASSEMBLY USING MAGNETS”. However, it has been found that the disclosed spectacles and sunshade-clip assembly has a low coupling force between spectacles and a sunshade-clip although it substantially eliminates the deterioration of outer appearance.

### SUMMARY OF THE INVENTION

Therefore, the present invention has been made in view of the above problems, and it is an object of the present invention to provide a spectacles and sunshade-clip assembly using magnets wherein magnet receiving members, provided at a sunshade-clip, are configured to protrude by the minimum extent so as to be hidden by spectacles when the sunshade-clip is completely detached to the spectacles, and the sunshade-clip can be mechanically seated on the spectacles, whereby a high coupling force based on multiple coupling points and favorable appearance of the spectacles and sunshade-clip assembly can be accomplished.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a spectacles and sunshade-clip assembly using magnets in accordance with the present invention, illustrating a state prior to assembling a sunshade-clip to spectacles;

FIG. 2 is a cross sectional view taken along the line A-A of FIG. 1;

FIG. 3 is a perspective view illustrating a first alternative embodiment of FIG. 1;

FIG. 4 is a perspective view illustrating a second alternative embodiment of FIG. 1;

FIG. 5 is a perspective view illustrating a third alternative embodiment of FIG. 1;

FIG. 6 is a perspective view illustrating a fourth alternative embodiment of FIG. 1;

FIG. 7 is a perspective view illustrating a fifth alternative embodiment of FIG. 1; and

FIG. 8 is a perspective view illustrating a sixth alternative embodiment of FIG. 1.

### DETAILED DESCRIPTION OF THE INVENTION

Now, preferred embodiments of a spectacles and sunshade-clip assembly using magnets in accordance with the present invention will be described in detail with reference to the annexed drawings.

In the following description, since left and right sides of the sunshade-clip are symmetrical, only one side will be designated by reference numerals and explained. This same is true in the case of the spectacles.

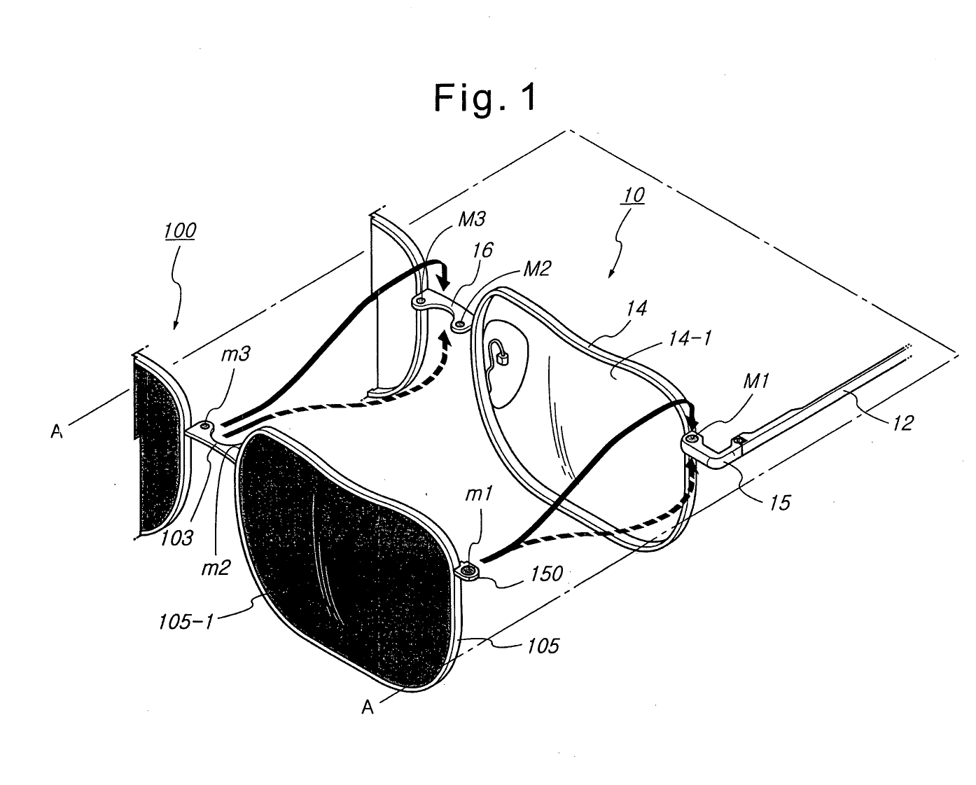

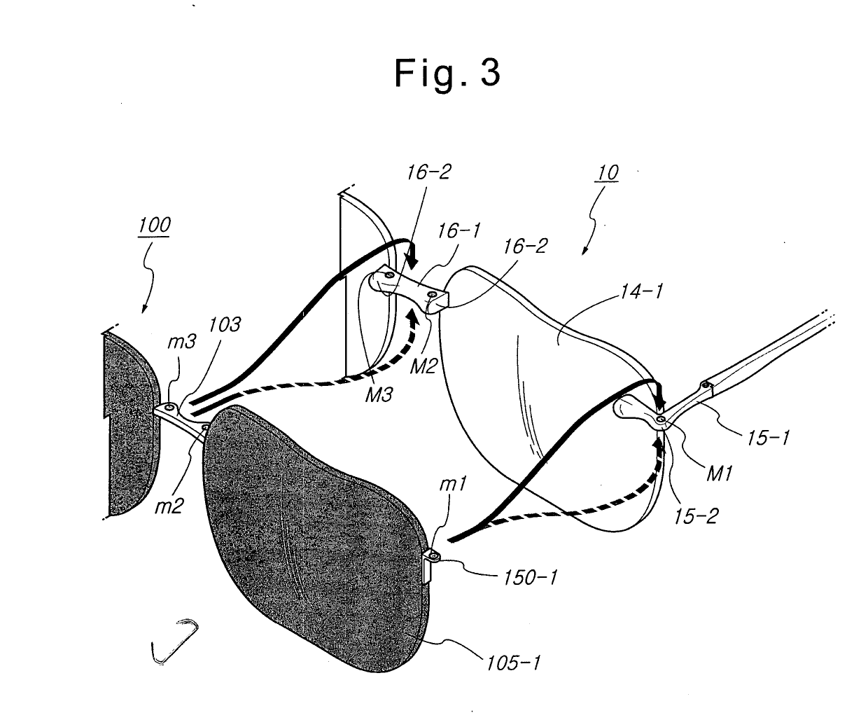

Referring to FIG. 1, the spectacles and sunshade-clip assembly of the present invention comprises spectacles 10, and a sunshade-clip 100 to be detachably attached to the spectacles 10 by use of one or more magnets. The spectacles 10 include a lens frame, which is made of material freely selected from among various materials including metal, plastic, etc. Of course, as will be described hereinafter with reference to FIG. 3, the spectacles may take the form of frameless spectacles. In a state wherein the sunshade-clip 100 is attached to the spectacles 10, the spectacles 10 have both functions of sunglasses and corrective spectacles.

In an embodiment of the present invention, the spectacles 10 include: a pair of metal lens frames 14 for receiving a pair of prescription lenses 14-1, respectively; a spectacle bridge 16 to connect the lens frames 14 to each other; a pair of temple arms 12; a pair of approximately L-shaped hinge members 15 affixed to opposite outer ends of the pair of lens frames 14 and adapted to hingedly connect the lens frames 14 to the temple arms 2, respectively.

The sunshade-clip 100, to be detachably attached to the spectacles 10, includes: a pair of sunshade lens frames 105 to receive sunshade lenses 105-1, respectively, the sunshade lens frames 105 having the same shape as that of the lens frame 14 of the spectacles 10; and a clip bridge 103 to connect the sunshade lens frames 105 to each other.

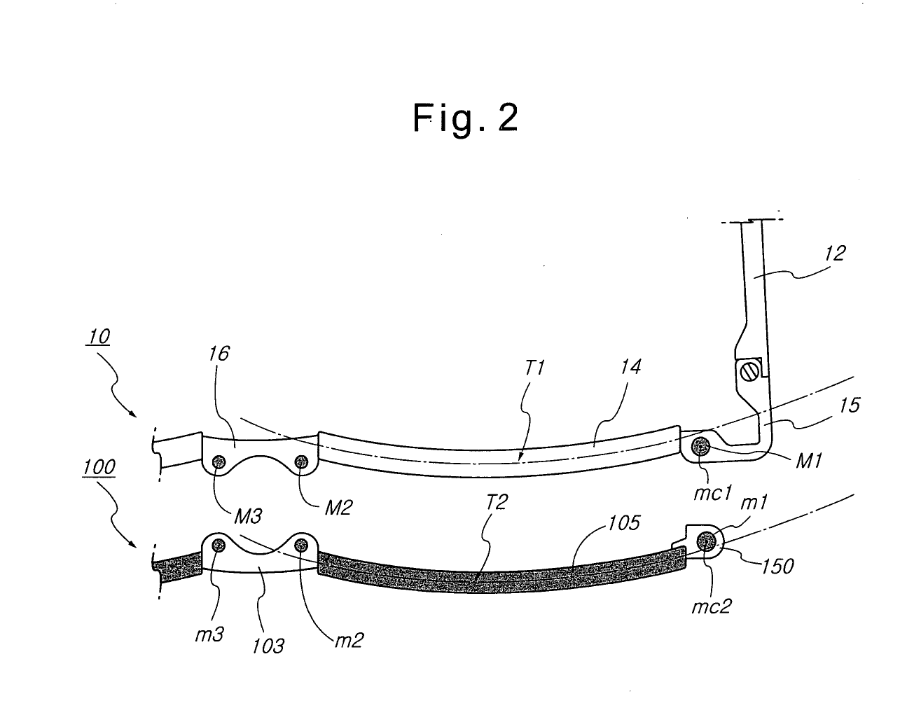

In addition to the above mentioned components, referring to FIGS. 1 and 2, the sunshade-clip 100 further includes a pair of magnet ribs 150 for receiving clip magnets m1 therein, respectively. The magnet ribs 150 are short fixed members extending in a lateral direction from opposite ends of the sunshade lens frames 105. Each of the clip magnets m1 is inserted into the relevant magnet rib 150 such that a magnet center mc2 thereof is located close to the spectacles 10, i.e. at a rear side of an arc axis T2 that is an imaginary extension of the curved sunshade lens frame 105.

The center clip bridge 103 of the sunshade-clip 100 is provided with a pair of clip bridge magnets m2 and m3. Similarly, centers of the clip bridge magnets m2 and m3 are located at the rear side of the arc axis T2 of each of the sunshade lens frames 105.

Corresponding to the magnet ribs 150 of the sunshade-clip 100, the approximately L-shaped hinge members 15 of the spectacles 10 are affixed to opposite outer ends of the lens frames 14 to protrude forward relative to the lens frames 14.

The hinge members 15 of the spectacles 10 are used to receive a pair of spectacle magnets M1, respectively. Each of the spectacle magnets M1 is inserted into the relevant hinge member 15 such that a magnet center mc1 thereof is located at a front side of an arc axis T1 that is an imaginary extension of the lens frame 14, to correspond to an associated one of the clip magnets m1 provided at the magnet rib 150 of the sunshade-clip 100.

Similarly, the spectacle bridge 16 of the spectacles 10 is configured to receive a pair of spectacle bridge magnets M2 and M3 at positions corresponding to the clip bridge magnets m2 and m3 of the clip bridge 103.

With the above described configuration, the spectacle magnets M1 inserted in the hinge members 15 of the spectacles 10 are magnetically coupled to the clip magnets m1 inserted in the magnet ribs 150 of the sunshade-clip 100, and simultaneously, the clip bridge magnets m2 and m3 of the clip bridge 103 are magnetically coupled to the spectacle bridge magnets M2 and M3 of the spectacle bridge 16, such that the magnet centers mc1 and mc2 are located at the front side of the arc axis T1 of the spectacles 10.

Accordingly, when the sunshade-clip 100 is completely attached to the spectacles 10, the sunshade lens frames 105 of the sunshade-clip 100 are located inward of the hinge members 15 of the spectacles 10 to be recessed relative to the hinge members 15. This has the effect of hiding protruding portions, and thus, achieving a great improvement in the outer appearance of the spectacles and sunshade-clip assembly.

As shown in FIG. 1, the sunshade-clip 100 may access upwardly or downwardly to the spectacles 10 in accordance with the user's selection. Such a selective attachment of the sunshade-clip 100 is possible because of the use of the plurality of magnets.

FIG. 3 illustrates a first alternative embodiment of the present invention, which has the same technical idea as that of the above described embodiment.

In the first alternative embodiment, each of hinge members 15-1 and a nose bridge 16-1 of the spectacles 10 have an aesthetic shape having a protruding portion with respect to the magnets. Specifically, each of the hinge members 15-1 has a forwardly-protruding magnet insertion portion 15-2, and the nose bridge 16-1 has a pair of forwardly protruding magnet insertion portions 16-2. Also, a sunshade-clip of the first alternative embodiment is a frameless sunshade-clip wherein a pair of colored plastic sunshade lenses 105-1 are connected to each other by use of the clip bridge 103, and a pair of magnet ribs 150-1 are directly attached to opposite ends of the sunshade lenses 105-1, respectively.

Similarly, the sunshade-clip 100 is attached to the spectacles 10 such that the magnet centers mc1 and mc2 are located at the front side of the arc axis T1 of each of the spectacle lenses 14-1. Accordingly, the sunshade lenses 105-1 of the sunshade-clip 1 00 are able to come into close contact with the spectacle lenses 14-1, so as to completely hide the spectacle lenses 14-1, resulting in an increase in aesthetic value of the spectacles and sunshade-clip assembly.

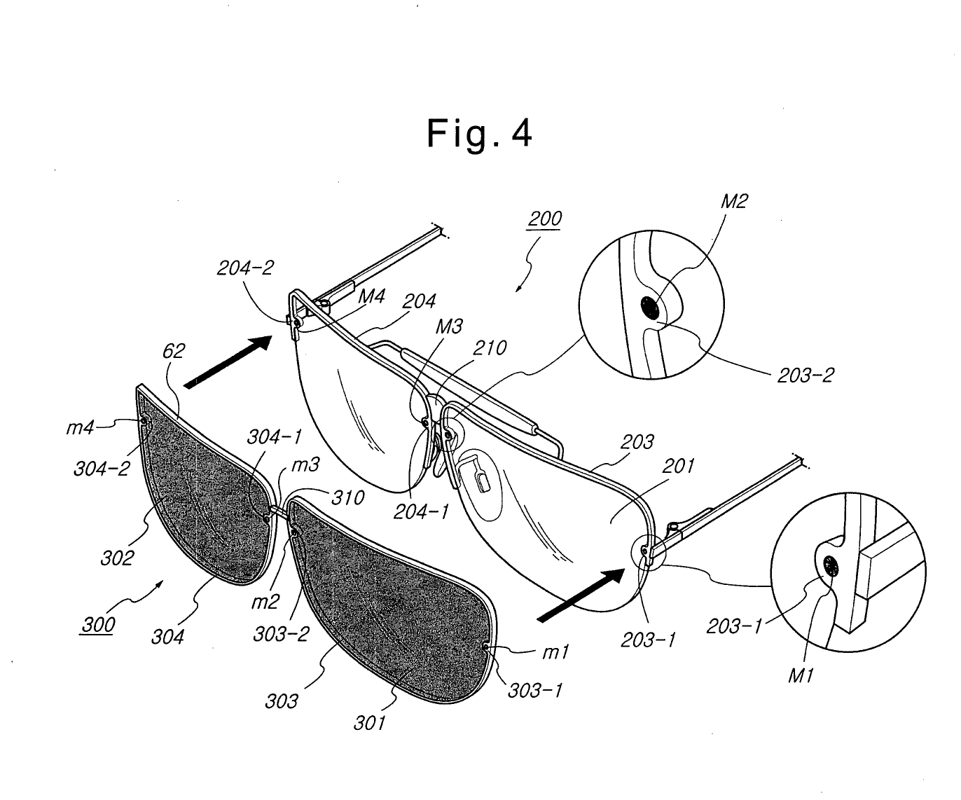

FIG. 4 illustrates a second alternative embodiment of the present invention in which a sunshade-clip is detachably attached to sports-wear spectacles to open and close the spectacles.

In the second alternative embodiment, a sunshade-clip 300 includes: a pair of sunshade lenses 301 and 302, which are formed by molding colored plastic plates; a pair of sunshade lens frames 303 and 304 for receiving the sunshade lenses 301 and 302, respectively; a clip bridge 310 to connect the sunshade lens frames 303 and 304 to each other; and a plurality of magnet holders 303-1, 303-2, 304-1, and 304-2 protruding inward from opposite ends of each of the sunshade lens frames 303 and 304.

As shown in FIG. 4, preferably, the plurality of magnet holders 303-1, 303-2, 304-1, and 304-2 are integrally formed with the sunshade lens frames 303 and 304, and a plurality of magnets m1, m2, m3, and m4 are inserted into the magnet holders 303-1, 303-2, 304-1, and 304-2, respectively.

In the second alternative embodiment, spectacles 200 include: a pair of spectacle lenses 201 and 202; a pair of spectacle lens frames 203 and 204; a spectacle bridge 210; and a plurality of spectacle magnet holders 203-1, 203-2, 204-1, and 204-2 protruding inward from opposite ends of each of the spectacle lens frames 203 and 204. A plurality of spectacle magnets M1, M2, M3, and M4 are inserted into the magnet holders 203-1, 203-2, 204-1, and 204-2, respectively, to correspond to the magnets m1, m2, m3, and m4 of the sunshade-clip 300. With the use of the corresponding magnets, the sunshade-clip 300 is able to be completely attached to a front side of the spectacles 200.

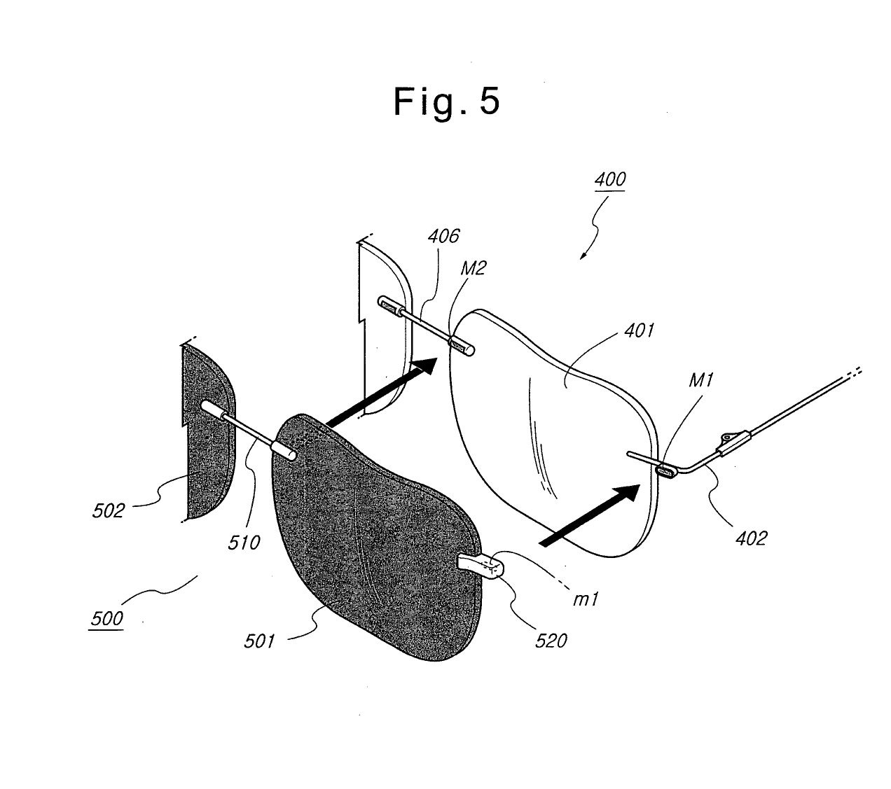

FIG. 5 illustrates a third alternative embodiment of the present invention in which a sunshade-clip is applicable to wire type spectacles having no lens frames.

In the third alternative embodiment, the frameless spectacles 400 include: a pair of spectacle lenses 401; a pair of hinge members 402 directly fixed to opposite ends of the spectacle lenses 401; a bar shaped spectacle bridge 406; a pair of spectacle magnets M1 fixed to front positions of the hinge members 402, respectively; and a pair of spectacle bridge magnets M2 fixed to front positions of the spectacle bridge 406. With this configuration, the magnets M1 and M2 are forwardly protruded relative to the spectacles 400. Meanwhile, the spectacle bridge magnets M2 may be inserted into the spectacle bridge 406 or the spectacle bridge 406 may be formed of a magnetized material.

A frameless sunshade-clip 500, to be detachably attached to the spectacles 400, includes: a pair of sunshade lenses 501 and 502 formed of colored plastic plates; a bar shaped clip bridge 510 to connect the sunshade lenses 501 and 502 to each other, the clip bridge 510 being made of magnetically attractable metallic material; and a pair of clip hinges 520 fixed at opposite ends of the sunshade lenses 501 and 502 to receive clip magnets m1, respectively, to correspond to the spectacle magnets M1 of the hinge members 402 of the spectacles 400.

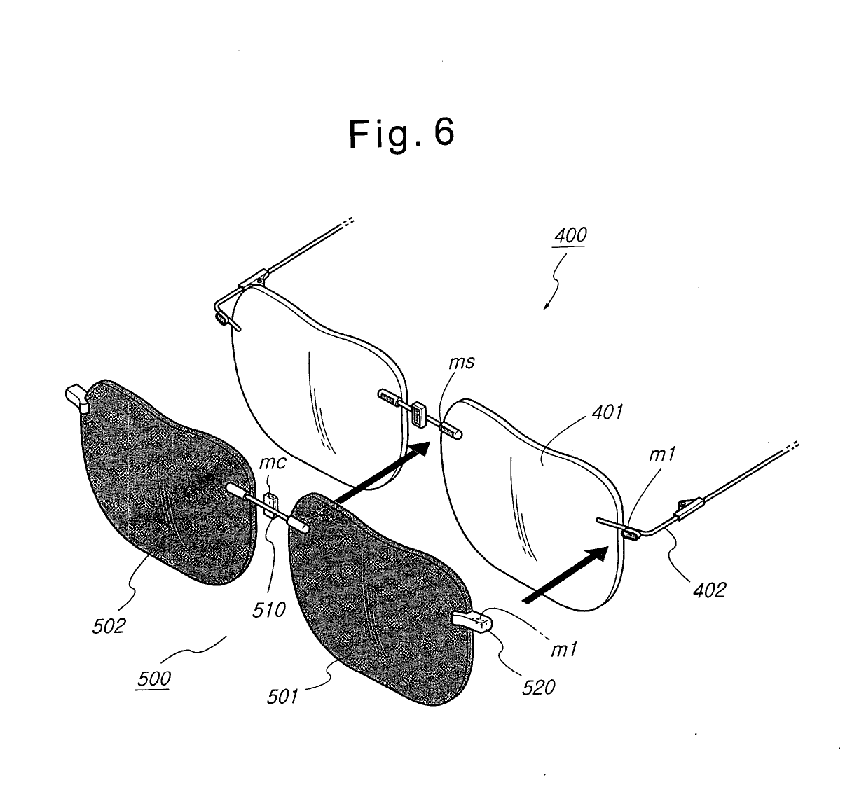

FIG. 6 illustrates a fourth alternative embodiment of the present invention, which is slightly different from FIG. 5. In addition to the configuration of FIG. 5, in the fourth alternative embodiment, a spectacle bridge magnet ms is additionally fixed to the bar shaped spectacle bridge 406, and a clip bridge magnet mc is additionally fixed to the bar shaped clip bridge 510, to achieve an increase in coupling force between the sunshade-clip 500 and the spectacles 400.

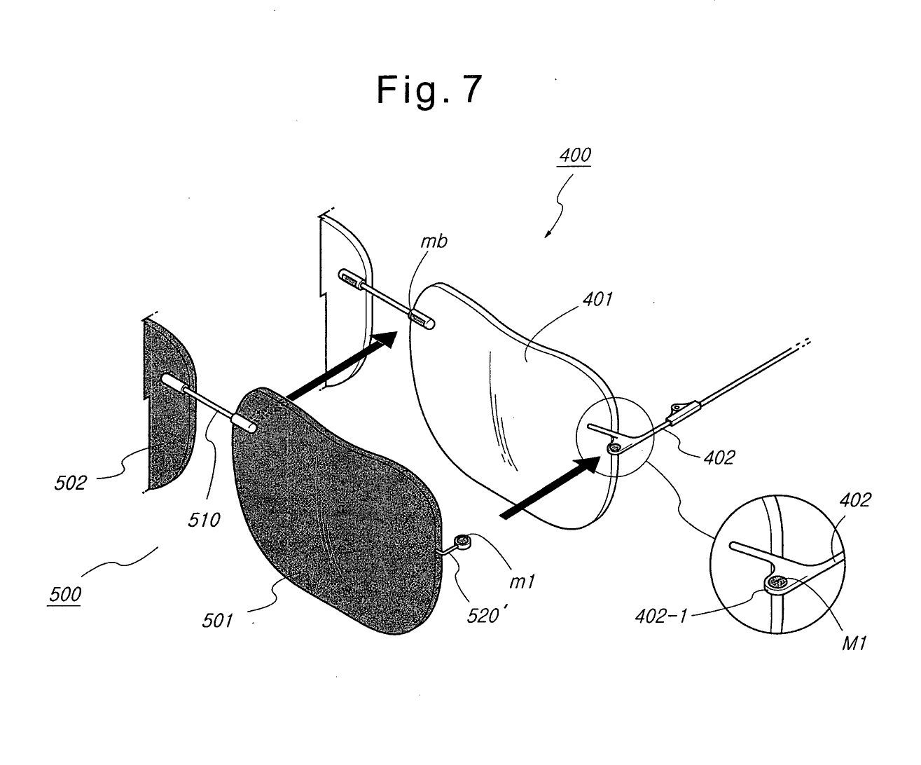

FIG. 7 illustrates a fifth alternative embodiment of the present invention, which is slightly different from FIG. 5. In addition to the configuration of FIG. 5, in the fifth alternative embodiment, each of the hinge members 402 of the spectacles 400 is configured to have a forwardly protruding portion 402-1 such that the relevant spectacle magnet M1 is horizontally received in the forwardly protruding portion 402-1. Correspondingly, the sunshade-clip 500 includes a pair of magnet arms 520′ each having a rearwardly bent L-shaped bar shape. In this case, each of the clip magnets m1 is horizontally received in a rear end of the relevant magnet arm 520′.

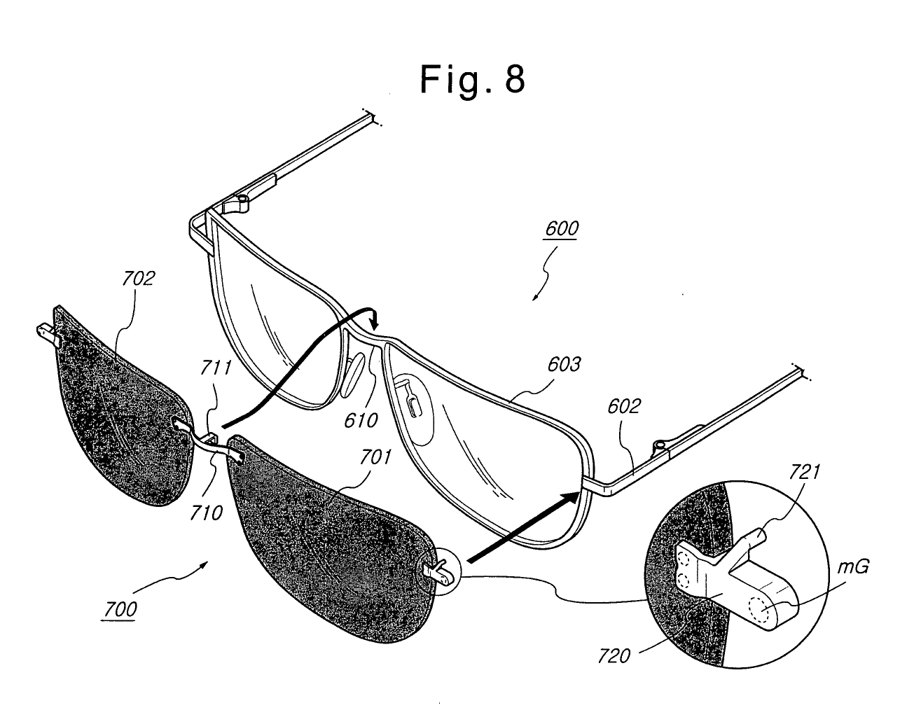

FIG. 8 is a perspective view illustrating a sixth alternative embodiment of the present invention. As shown in FIG. 8, spectacles 600 include: a spectacle lens frame 603 having a spectacle bridge 610; and a pair of hinge members 602 provided at opposite ends of the spectacle lens frame 603. The hinge members 602 may be made of magnetically attractable metallic material or may have magnets (not shown) inserted therein.

A sunshade-clip 700 of the sixth alternative embodiment includes: a pair of sunshade lenses 701 and 702 formed of colored plastic plates; a clip bridge 710 integrally formed with a hook 711 to be caught by the spectacle bridge 610 of the spectacles 600; and a pair of clip hinges 720 fixed at opposite ends of the sunshade lenses 701 and 702.

Each of the clip hinges 720 is integrally formed at an upper end thereof with a holding bar 721. The clip hinge 720 is configured to receive a clip magnet mG therein, so as to correspond to the relevant hinge member 602 of the spectacles 600.

Although the above described respective embodiments exemplify the use of pairs of corresponding magnets provided at both the spectacles and sunshade-clip, it will be understood that some magnets provided at one of the spectacles and sunshade-clip may be substituted by material selected from among a variety of magnetically attractable materials, to be magnetically coupled with the other magnets provided at the other one of the spectacles and sunshade-clip.

As apparent from the above description, the present invention provides a spectacles and sunshade-clip assembly in which a sunshade-clip can be more securely coupled to spectacles by use of magnets provided at multiple corresponding positions thereof, differently from the prior art wherein magnets are provided only at hinge members of both the spectacles and the sunshade-clip. This has the effect of achieving a remarkable increase in coupling force between the sunshade-clip and the spectacles, to prevent unintentional separation of the sunshade-clip when in use. Also, in accordance with the present invention, in a state wherein the sunshade-clip is completely attached to the spectacles, the sunshade-clip is located inward of the foremost edge of the spectacles to be recessed relative to the foremost edge. This has the effect of reducing the provision of protruding portions, achieving a favorable appearance and safe wearing of the spectacles and sunshade-clip assembly.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A spectacles and sunshade-clip assembly comprising: spectacles including a spectacle bridge to connect a pair of lens frames or a pair of prescription lenses to each other, and a pair of approximately L-shaped hinge members affixed to opposite outer ends of the lens frames or prescription lenses, and a pair of temple arms; and a sunshade-clip including a clip bridge to connect a pair of sunshade lens frames or a pair of colored sunshade lenses to each other, the sunshade-clip being detachably attachable to the spectacles by means of a plurality of magnets,
wherein the sunshade-clip further includes: a pair of magnet ribs fixed to opposite ends thereof; a pair of clip magnets inserted into the magnet ribs, respectively; and at least one clip bridge magnet inserted into the clip bridge,
wherein the spectacles further include: a pair of spectacle magnets inserted into the hinge members at opposite ends of the spectacles, respectively, to correspond to the clip magnets; and at least one spectacle bridge magnet inserted into the spectacle bridge, to correspond to the clip bridge magnet, and
wherein the magnets of the sunshade-clip and the magnets of the spectacles are positioned to be coupled to each other at positions spaced apart forward from arc axes that are center axes of the curved spectacle lens frames or prescription lenses of the spectacles.

2. The assembly as set forth in claim 1, wherein the coupling of both the sunshade-clip and the spectacles is accomplished by coupling the clip magnets, which are provided at opposite ends of the sunshade-clip, to the spectacle magnets provided at the hinge members located at opposite ends of the spectacles, or by coupling the at least one clip bridge magnet, which is inserted into the clip bridge of the sunshade-clip, to the at least one spectacle bridge magnet provided at the spectacle bridge of the spectacles.

3. The assembly as set forth in claim 1, wherein, instead of providing the pair of magnets at corresponding positions of both the spectacles and the sunshade-clip to be attached to each other, the magnet of one of the spectacles and the sunshade-clip is substituted by magnetically attractable material.
